(19) United States
(12) Patent Application Publication
(10) Pub. No.: US 2011/0248855 A1
(43) Pub. Date: Oct. 13, 2011

(54) METHOD AND SYSTEM FOR ANALYZING VARIATIONS IN MONITORED GAS FLOW USING FLOW SIGNAL ANALYSIS AND AMPLIFICATION

(76) Inventor: Geoffrey P. Brown, Vancouver (CA)

(21) Appl. No.: 12/898,507

(22) Filed: Oct. 5, 2010

Related U.S. Application Data
(60) Provisional application No. 61/248,743, filed on Oct. 5, 2009.

(51) Int. Cl. G08B 21/00; G01M 3/26

(52) U.S. Cl. 340/605; 702/51

(57) ABSTRACT

A signal analysis method to enable flow and leak detection devices to accurately detect and amplify the signal from a flow measurement means detecting the pressure effects of very small leaks in contained fluid systems, and leaks in fluid systems that have small flows, where the raw signal is an order of magnitude less than the random pressure fluctuations in the contained system, and is an order of magnitude less than the effects of temperature and manufacturer's variations in the sensing device and the components used in the manufacture of the flow detection device. The method involves windowing the signal in a small section of the range of the sensor, then periodically re-centering the signal.

### CROSS REFERENCE TO RELATED APPLICATION

The present application claims the benefits, under 35 U.S.C. §119(e), of U.S. Provisional Application Ser. No. 61/248,743 filed Oct. 5, 2009 which is pending and is incorporated herein by this reference.

### TECHNICAL FIELD

The invention relates to the field of monitoring of fluid flow systems for leaks and more particularly methods of amplifying the effects of very small flows that occur in the supply pipe of contained fluid systems that have very small leaks.

### BACKGROUND

Various systems and methods of testing have been developed that shut a valve in the supply pipe to a contained fluid system and measure the decay of a signal detected by a pressure sensor over time, to determine the rate at which a system is leaking, or gas is flowing. This typically requires a full range pressure sensor to avoid over-pressurizing the sensor and to allow moderate to larger flows to be more accurately detected, and this makes such systems inherently less sensitive.

Systems have also been developed using various flow amplification measurement methods. Such methods include using a Venturi with a differential, pressure transducer, or a smaller bypass pipe through which all flow is directed. These arrangements amplify the dynamic pressure signal by increasing the velocity of flow in the smaller diameter section. Since dynamic pressure, or equal drop in static pressure, varies as the square of velocity, the signal is amplified by the greater velocity in the constricted section, and the sensitivity increased. In the case of a Venturi, or any other differential flow measuring means, a more sensitive flow measurement means can be used because it does not have to withstand the full static pressure range, but only the dynamic pressure, which is equal to the drop in static pressure, caused by flow.

Typically flow measuring devices, and particularly, pressure transducer devices, have a temperature compensation signal conditioner, and the more accurate the compensation, the higher the price of the transducer. However, even very expensive sensors do not have sufficient signal resolution for measurement of very small flows. Such sensors are typically limited to a small percentage of maximum pressure range for reasonable accuracy. Consider a system where the maximum flow in a pipe is 5 ft./sec., amplified to 10 ft./sec. by a Venturi contraction. The pressure is proportional to velocity squared, or 100 ft.²/sec.². If the flow is 0.5 ft./sec. the pressure is proportional to 1, or about the range of accuracy of a sophisticated sensor with full scale set for the dynamic pressure range from a flow of 5 ft/sec. Suppose the velocity is 0.05 ft/sec, which would mean a sizeable leak, the pressure is proportional to 0.01, which is one thousandth of the transducer range. The transducer signal from such pressure change is less than the random pressure fluctuations in the pipe, and is well outside the manufacturer's tolerance, hysteresis and temperature variation of the pressure sensor, which typically exceeds 1%. The measurements can no longer be relied upon, and will be unable to provide a meaningful reading for lesser fluid flows from still smaller leaks.

In considering a leak detection system for a residential gas system, both price and accuracy are important. It is also necessary not to interfere with the normal use of the gas system, nor to have the device or test procedure extinguish any pilot light that may exist in the gas system. A small leak must be detected on top of the pilot light flow without extinguishing the pilot light, and the pilot light flow is already below the noise and the component manufacturer's tolerance level of the most sophisticated flow measurement devices, even when they are mounted in flow amplification devices as described above.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present method is independent of the basic physical flow amplification means, and is applicable to signals from both static and differential pressure transducer flow measuring and leak detection devices, and any other devices for which measurement depends on change in flow level or the change in pressure associated with such change in flow level. Typically flow measuring devices, and particularly, pressure transducer devices, have a temperature compensation signal conditioner, and the more accurate the compensation, the higher the price of the transducer. However, even very expensive transducers do not have sufficient signal resolution for measurement of very small flows. Such transducers are typically limited to a small percentage of maximum pressure range for reasonable accuracy, most commonly about 1-2% of full scale, the percentage being dictated by the need to accurately measure larger flows, and for the transducer to withstand the high pressures associated with such flows, or the total static pressure in the case of a flow measurement device that uses static pressure transducers.

The present method looks at only a few thousandths of the sensor range, and windows the signal to keep it in range. This window moves up and down the sensor range, depending upon the level of the signal, thereby not losing the capability of looking at a full scale signal. The input signal to the Operational Amplifier (op amp) has a range that, when amplified, far exceeds the range of the amplifier. This problem is addressed by continually monitoring the amplifier output and generating an offset signal that is summed with the input prior to amplification. The offset is generated by a Digital-to-Analogue Converter (DAC), and is stored in non-volatile memory so that it can be added back to the post-amplified signal in the processor.

This method does not need sophisticated temperature compensated measuring devices, since the method can be used by flow measuring devices to determine if a signal is actually due to a small flow or leak, and eliminate temperature, pressure, hysteresis and any other variations that the flow measurement means may have, despite being within the manufacturer's tolerance for such variations. Any flow measuring device using this method can measure, process and store, information in the non-volatile memory of a processor, and use this information to correct any future measurements for component manufacturing variations and temperature and pressure drift. In addition, pressure signals from pre-existing flows, unique to any installation, can be stored in the non-volatile memory of a device for future comparative reference. Such a signal could typically be the signature of one, or several, pilot lights that are installed in a residential or commercial gas system.

The invention relates to a method that allows a meaningful signal to be extracted and processed from a flow measurement means, where the signal is an order of magnitude below the sensor manufacturer's tolerance for temperature, pressure, hysteresis and other variations, thereby enabling flow measurement devices that measure the pressure effects of very small flows to reliably detect much smaller leaks than they would otherwise be capable of without utilizing this method.

The present invention thus provides a method to extract meaningful data from a pressure sensor signal that is an order of magnitude below the sensor manufacturer's tolerance for temperature, pressure, hysteresis and manufacturing variations, and to negate the effect of variations in the response of components used to manufacture flow measuring devices that use these pressure sensors.

The system comprises:

a) valve means for opening and closing the fluid supply line;

b) control means for controlling the valve means;

c) a pressure sensor means for sensing a flow within the supply line;

d) means for processing data from the sensing means;

e) means for storing processed data in non-volatile memory in the control means; and

f) a method of extracting and amplifying the signal at the pressure sensor means.

The present method provides a signal analysis method to enable flow and leak detection devices to accurately detect and amplify the signal from a flow measurement means detecting the pressure effects of very small leaks in contained fluid systems, and leaks in fluid systems that have small flows, where the raw signal is an order of magnitude less than the random pressure fluctuations in the contained system, and is an order of magnitude less than the effects of temperature and manufacturer's variations in the sensing device and the components used in the manufacture of the flow detection device.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

Table 1 shows typical Pressure Transducer Specifications.

FIG. 1 is a schematic of the system used in the method.

FIG. 2 is a flow chart illustrating the method of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The present method is useful in a METHOD AND SYSTEM FOR MONITORING GAS LEAKS BY AMPLIFICATION OF FLOW as disclosed in co-pending U.S. patent application Ser. No. 12/353,102 filed Jan. 13, 2009, which is incorporated herein by reference.

The present method amplifies the signal from a flow sensing means detecting the pressure effects of very small leaks in contained fluid systems, and leaks in fluid systems that have small flows, where the raw signal is an order of magnitude less than the random pressure fluctuations in the contained system, and is an order of magnitude less than the effects of temperature and manufacturer's variations in the sensing device. In the case of a very small, steady flows, it will provide data from which the signature of such small steady flows can be determined and stored, in order that such data can be used for comparative purposes at later scheduled, or operator initiated tests, for the purpose of determining if a small flow exists in addition to such small steady flow. The present method is applicable to any device that measures flow by sensing changes in flow level or pressure resulting from the flow level, and is applicable to both compressible fluids and non-compressible fluids. In the preferred embodiment test device using differential pressure transducers, amplifications of 50,000 times were found to generate accurately repeatable measurements when using constant current-type pressure transducers to detect pressure changes resulting from changes in flow level, and amplifications of 3,000 times for constant voltage-type pressure transducers, when looking at the Least Significant Bit (LSB) of the measuring device means multiplied by the fraction of the range of the flow measuring means used.

Residential houses and commercial businesses are generally serviced by a water supply line and a gas supply line. Various devices exist to determine if such systems have leaks. These devices frequently use static pressure within the supply line, or the change in static pressure resulting from a dynamic pressure change created by a physical flow amplification technique, and time, to measure the magnitude of and/or decay in pressure, thereby determining the magnitude of the flow or leak. Such flow measurement devices often include a valve to close off the supply system, enabling the static pressure in the system downstream of the valve to be monitored, and the static pressure decay of a known flow measured. If the flow is large enough to cause a change in pressure signal above the level of random pressure fluctuations, and above the threshold of the measuring device, the signal can be measured instantaneously with a differential sensor. However, as discussed previously, a pilot light-sized flow, or drip watering system, is below such threshold, and the magnitude of flow cannot be determined by such devices. Since such small pre-existing flows cannot be measured accurately, it is not possible to measure for a small leak that may exist in addition to such small flows.

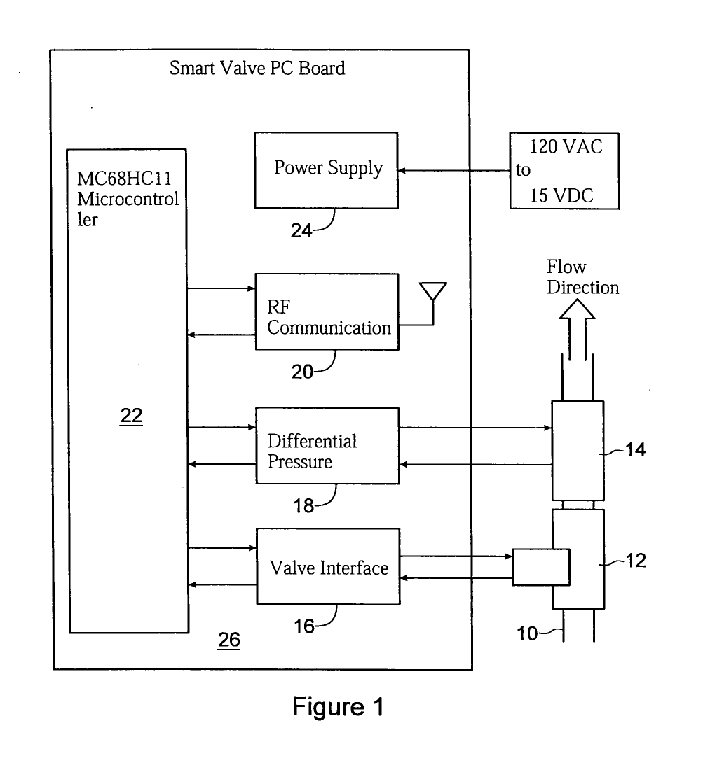

FIG. 1 shows a schematic diagram illustrating an embodiment of the system. A fluid supply line 10, such as a residential gas or water supply line, has a valve 12 and pressure sensor 14, which are controlled by a controller 22 mounted on printed circuit board 26. For example a MC68HC11 microcontroller manufactured by Motorola may be used. Valve 12 may be a solenoid valve manufactured by Fluid Control Division, Parker Hannifin. For a gas line, a Silicon Microstructures gas pressure transducer, model 5551 with an excitation of 1.50 mA @ 25 degrees C. may be used. Table 1 illustrates the specifications for the Silicon Microstructures gas pressure transducer, model 5551. Microcontroller 22 activates valve 12 through interface 16 and the change in pressure measured by transducer 14, as described above, is communicated to the microcontroller 22 by differential pressure interface 18. Microcontroller 22 is powered by power supply 24. Microcontroller 22 monitors the differential pressure change through periodic monitoring as described above and if a leak situation is calculated, communicates an alarm through RF communication channel 20.

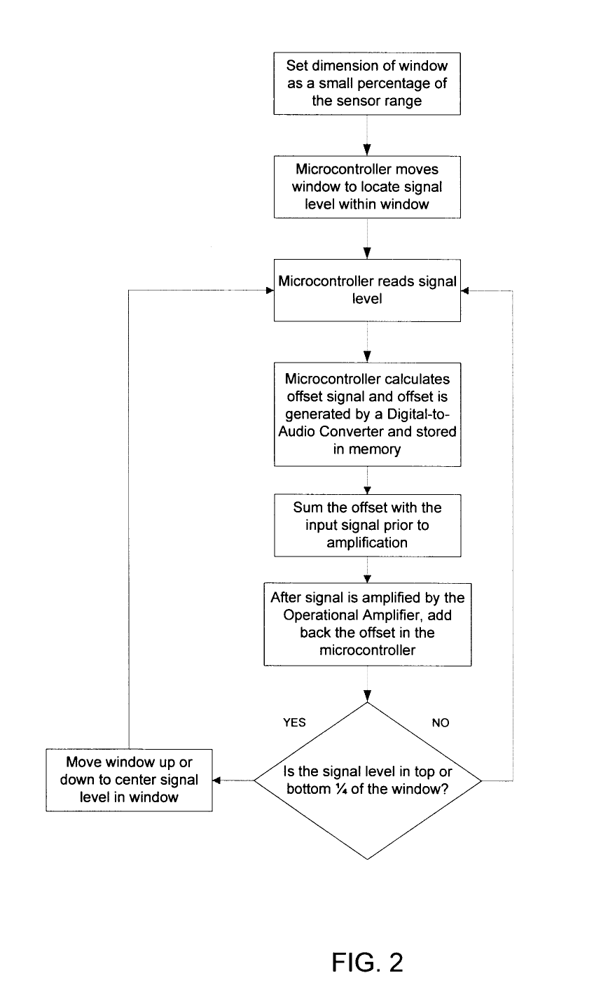

The method is illustrated schematically in the flowchart shown in FIG. 2. it is implemented on the controller by appropriate code. Since the range of pressure signal values from the sensor that must be read far exceeds the range of the Analogue-to-Digital Converter (ADC), a windowing method is used. The window provides access to a small range (a window) within the larger range that must be covered. The present method looks at only a few thousandths of the sensor range by windowing the signal. This window moves up and down the range depending upon the level of the signal, thereby retaining the capability of measuring a full scale signal. The window is digitally adjusted by the microcontroller 22 of the flow measuring device. The signal cannot be allowed to move outside of the window because the signal would not be useable as the signal value would not be known.

The signal is kept within the window by breaking it into four overlapping sub-windows to cover the 5V Analogue-to-Digital Converter (ADC) range. When the reading rises above the 75% point of a window, the window is adjusted up to make the reading near the center of the new window. When the reading drops below the 25% point, the window is adjusted down, and the reading is once again centered. This method allows the upper and lower ¼ of each window to be used as a buffer to prevent rapidly changing signals from moving outside of the window. The signal should be read at least 32 times per second for reliable signal detection. The fastest signal at the pressure sensor is caused by the surge when the supply line valve is opened, and the present method allows the flow measurement device to see a signal of 1024 LSB's without stepping the window. Such a flow signal would be expected from a gas flow equivalent to several pilot lights.

Pressure may be read, for example, using an 8-bit ADC. In that case, an 8-bit window offset may be added to the 12-bit sensor reading to produce a 16-bit value. The total range of the signal amplifier must also take into account the sensor offset. Offset=−2.0 mV to +2.0 mV Total Range=−2.2 mV to 4.75 mV. The signal will eventually be read with an 8-bit ADC having a range of 0-5V. The maximum resolution of the ADC is 5/256 or 19.53 mV. In order to relate the sensor's resolution to 1 LSB of the ADC, one needs to amplify the 0.390 mV sensor signal to 19.53 mV at the ADC. This is a gain of approximately 50,000. Covering a sensor range of 6.95 mV with a gain of 50,000 produces a range 348 V at the ADC, so a window is used that can move around and give the resolution needed without reducing the range. The window is digitally adjusted by the microcontroller 22. To avoid the signal moving outside of the window, four sub-windows overlap to cover the 5V ADC range. When the reading rises above the 75% point, the window is adjusted up. Since there are four sub-windows, the reading is now near the center of the new window. When the reading drops below the 25% point, the window is adjusted down. The reading is once again centered. The signal is read 32 times per second. The fastest signals (i.e. 0.3G at 8 Hz) will cause the ADC reading to vary by about 1.5V per reading. If overlapping sub-windows are not used, this signal could go off of the scale and cause erroneous readings. Signals faster or larger than this may go off scale. Sampling can be done at 64 Hz just to keep the windows updated.

The input signal to the Operational Amplifier (op amp) has a range that, when amplified, far exceeds the range of the amplifier. This problem is addressed by continually monitoring the amplifier output and generating an offset signal that is summed with the input prior to amplification. The offset is generated with a Digital-to-Analogue Converter (DAC), and is stored in non-volatile memory, so that it can be added back to the post amplified signal in the processor. The processor determines the amount of each window step by adjusting the window when the flow measuring device has determined there is no flow, or resulting signal change, and measures the resulting offset. This offset is kept in a table so that temperature and component manufacturer's tolerance variations for each individual flow measurement device are calibrated into this offset.

When a flow measuring device uses static pressure transducers as the flow measurement means, the device can be subject to pressure drift as well as temperature, and the offset will not vary directly in relationship to temperature changes. All device component variations are relatively constant for each individual device. However, when there is variation with pressure, in addition to temperature, a double iterative technique to solve for constants of 3^{rd} order correcting equations for temperature and pressure are employed. When an apparent signal is read, the flow measuring device tests to see if it is a real flow signal by closing and opening the valve. If the test determines there is no flow, the device stores the pressure and temperature reading, and the device reading, which becomes an offset value. When it has sufficient readings it applies a correcting algorithm. Typically such equations are solved by a matrix inversion technique. There is insufficient computational capacity in the processor of most flow measuring devices to invert a 16×16 matrix, and still undertake the tasks the device demands of the processor. To reduce demands on the processor, a double iterative technique can be used. Development of such equations allows the flow measurement device's processor to read and analyze a transducer signal, enter the temperature and pressure readings in the correcting equations, or look up table if there is no pressure variation, and determine an offset to adjust the signal, allowing the flow measuring device to better determine whether the signal indicates flow.

Using such a small part of the range of a transducer creates another problem. The signal being measured is often smaller than the random pressure fluctuations in the pipe from which the signal is being detected. The raw signal is filtered using a Fourier analysis technique which allows extraction of a change in flow level from what otherwise appears as random noise. This method uses a series of simple, low pass box filters. Filters that pass only very low frequencies take a long time to change levels when there is a sudden change in the input signal as would happen when a large flow suddenly occurs, characteristic of when a furnace or hot water heater in a gas system activates. This method uses the large difference between the filtered output and the unfiltered input to change the filter bandwidth, so that it can track the large change. As soon as the filtered value catches up, the filter coefficients return to the normal settings and again become a very low pass filter. The flow level is derived from this output of the very low pass filter.

A contained liquid system behaves very similarly to the contained gas system described above, and the signature of any steady flow, such as a drip water system can be equally retained and used for future comparison. The static pressures are generally much higher in a contained liquid system due to the incompressibility of liquid, being typically in the 30 to 70 psi range for residential and business water systems, depending upon supply pressure, demand and whether a pressure reducing valve is present in the supply pipe. However, similar to the contained gas system, temperature, pressure, hysteresis and manufacturer's variations of the flow measuring device have no effect on the capability of the measuring device's capability to reliably detect a signal, and repeat such test results at a later scheduled, or user initiated time.

In the embodiment of the test device, a leak as small as a single drip from a tap is detectable in a typical residential or commercial water system without any other flow. When the valve in the supply pipe to the contained water system is opened, the small pressure charging pulse passes into the water system, first passing the static pressure port and raising the pressure there, which gives a differential signal between the static pressure port and the dynamic pressure port. The pulse subsequently passes the dynamic pressure port and the differential signal returns to zero.

The invention thus provides a signal analysis method to enable flow and leak detection devices to accurately detect and amplify the signal from a flow measurement means detecting the pressure effects of very small leaks in contained fluid systems, and leaks in fluid systems that have small flows, where the raw signal is an order of magnitude less than the random pressure fluctuations in the contained system, and is an order of magnitude less than the effects of temperature and manufacturer's variations in the sensing device and the components used in the manufacture of the flow detection device. The invention further provides a windowing system, which allows greater resolution of the sensor range, and which tracks the signal up and down the range, depending upon the level of the signal, thereby retaining the capability of measuring full scale signals.

The invention also provides a pressure, temperature and testing means that calibrates a flow measurement device to each unique installation in order to negate pressure, temperature, hysteresis, sensor range tolerances and other variations in pressure sensors, and variations in other flow measuring device components. The invention also provides a low pass box filter method that changes filter bandwidth in order to track large signals, and returns the filter coefficients to their normal settings when the filtering catches up to the rate of signal change.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

TABLE 1
Gas Pressure Transducer Specifications

| Parameter | Min | Typ | Max | Units |
|---|---|---|---|---|
| Excitation | 0.00 | 1.50 | 3.00 | mA |
| Output | | | | |
| Span | 25.00 | 50.00 | 75.00 | mV |
| Offset | −2.00 | ±0.20 | 2.00 | mV |
| Temperature | | | | |
| TC Span (0-70° C.) | −1.20 | ±0.20 | 1.20 | % FS/100° C. |
| TC Offset (0-70° C.) | −2.40 | ±0.20 | 2.40 | % FS/100° C. |
| Hysteresis | −0.30 | ±0.05 | 0.30 | % FS |
| Accuracy | | | | |
| Linearity | −0.15 | ±0.05 | 0.15 | % FS |
| Repeatability | −0.30 | ±0.05 | 0.30 | % FS |
| Pressure | −0.30 | ±0.05 | 0.30 | % FS |
| Hysterisis | | | | |
| Impedance | | | | |
| Z input | 2.20 | 3.00 | 3.80 | KΩ |
| Z output | 2.90 | 3.30 | 3.80 | KΩ |
| Temperature Range | | | | |
| Calibration | 0 | . . . | 70 | ° C. |
| Operating | −40 | . . . | 85 | ° C. |
| Dynamic | | | | |
| Characteristics | | | | |
| Proof Pressure | 3X | | | FS PSI (max) |
| Burst Pressure | 5X | | | FS PSI (max) |

Silicon Microstructures Model 5551 w/excitation = 1.50 mA @ 25° C.

The sensor driving electronics provides a constant 1.5 mA current.

Experimentation has shown that the SM sensor can reliably provide a signal resolution of 0.230 μV. Amplifying this signal to a value that can be seen by the 8-bit ADC (19.53 mV) requires the use of an 8-bit bit DAC in the windowing system. Production systems will, most likely, not be able to reliably produce the 0.230 μV signal. Because of these factors, the signal resolution will be specified at 0.390 μV.

What is claimed is:

1. A method of analyzing fluid flow in a fluid supply line, wherein said supply line is provided with has a valve and a pressure sensor which are controlled by a controller, the method comprising the steps of:
a) setting a dimension of a window as a portion of the sensor range;
b) moving the window to locate the signal within the window;
c) reading the signal level;
d) calculating an offset signal
e) generating the offset signal and storing it in memory;
f) summing the offset with the input signal prior to amplification;
g) after amplification, adding back the offset in the controller;
h) if the signal level is in the top or bottom portion of the window, centering the signal level in the window and repeating steps c-g.

2. The method of claim 1 wherein said signal is read a plurality of times per second.

3. The method of claim 2 wherein said signal is read at least 32 times per second.

4. The method of claim 1 wherein the window is broken into a plurality of sub-windows, comprising said top and bottom portions of the window.

5. The method of claim 4 wherein the window is broken into four sub-windows.

6. The method of claim 4 wherein the window is broken into four sub-windows.

7. The method of claim 1 wherein pressure is read by an 8 bit analogue-to-digital converter and an 8-bit window offset is added to a 12-bit sensor reading.

8. The method of claim 7 wherein the window offset is between −2.2 mV. and 4.75 mV.

9. The method of claim 7 wherein the window is sub-divided into four sub-windows to cover a 5V range of the analogue-to-digital converter.

10. The method of claim 1 wherein if a leak situation is calculated, said control means communicates an alarm through a communication channel.

11. A system for analyzing fluid flow in a fluid supply line, wherein said supply line is provided with has a valve and a pressure sensor which are controlled by a controller, said system comprising:
a) valve means for opening and closing the fluid supply line;
b) control means for controlling the valve means;
c) means for sensing a flow within the supply line comprising a pressure sensor having a sensor range;
d) means for processing data from said pressure sensor;
e) means for storing processed data in memory in the control means; and
f) said control means having computer readable program code embodied therein, said computer readable program code adapted to be implemented to execute a method for analyzing fluid flow in a fluid supply line, said method, the method comprising the steps of:
i) setting a dimension of a window as a portion of the sensor range;
ii) moving the window to locate the signal within the window;
iii) reading the signal level;
iv) calculating an offset signal;
v) generating the offset signal and storing it in memory;
vi) summing the offset with the input signal prior to amplification;
vii) after amplification, adding back the offset in the controller;
viii) if the signal level is in the top or bottom portion of the window, centering the signal level in the window and repeating steps iii)-vii).

12. The system of claim 11 wherein said signal is read a plurality of times per second.

13. The system of claim 12 wherein said signal is read at least 32 times per second.

14. The system of claim 11 wherein the window is broken into a plurality of sub-windows, comprising said top and bottom portions of the window.

15. The system of claim 14 wherein the window is broken into four sub-windows.

16. The system of claim 14 wherein the window is broken into four sub-windows.

17. The system of claim 11 wherein pressure is read by an 8 bit analogue-to-digital converter and an 8-bit window offset is added to a 12-bit sensor reading.

18. The system of claim 17 wherein the window offset is between −2.2 mV. and 4.75 mV.

19. The system of claim 17 wherein the window is sub-divided into four sub-windows to cover a 5V range of the analogue-to-digital converter.

20. The system of claim 11 further comprising a communication channel whereby if a leak situation is calculated, said control means communicates an alarm through said communication channel.
